(19) United States
(12) Patent Application Publication
(10) Pub. No.: US 2025/0158345 A1
(43) Pub. Date: May 15, 2025

(54) PUMP LIGHT GENERATION APPARATUS, OPTICAL AMPLIFIER AND PUMP LIGHT GENERATION METHOD

(71) Applicant: NIPPON TELEGRAPH AND TELEPHONE CORPORATION, Tokyo (JP)

(72) Inventors: Hiroto KAWAKAMI, Musashino-shi (JP); Takayuki KOBAYASHI, Musashino-shi (JP); Yoshiaki KISAKA, Musashino-shi (JP); Shoichiro KUWAHARA, Musashino-shi (JP)

(73) Assignee: NIPPON TELEGRAPH AND TELEPHONE CORPORATION, Tokyo (JP)

(21) Appl. No.: 18/840,031

(22) PCT Filed: Sep. 14, 2022
(86) PCT No.: PCT/JP2022/034368

§ 371 Date: Aug. 20, 2024

(30) Foreign Application Priority Data
Feb. 25, 2022 (WO) PCT/JP2022/007892

(51) Int. Cl. H01S 3/10; H01S 3/094; H01S 3/102; H01S 3/30; H04J 14/06

(52) U.S. Cl. CPC H01S 3/10061; H01S 3/094069; H01S 3/1028; H01S 3/30; H04J 14/06

(57) ABSTRACT

A pump light generation device including: a first multi-mode laser that outputs first pump light; a second multi-mode laser that outputs second pump light; a first pump current/temperature controller that controls a temperature and a pump current of the first multi-mode laser; a second pump current/temperature controller that controls a temperature and a pump current of the second multi-mode laser; a first polarization maintaining variable optical attenuator that adjusts a light intensity while keeping a polarization state in a linearly polarized wave and outputs the first pump light; a second polarization maintaining variable optical attenuator that adjusts a light intensity while keeping a polarization state in a linearly polarized wave and outputs the second pump light; and a polarization multiplexing circuit that polarization-multiplexes and output the pump light, in which the first pump current/temperature controller and the second pump current/temperature controller perform control such that the longitudinal modes in the first pump light and the second pump light do not overlap each other, and the first polarization maintaining variable optical attenuator and the second polarization maintaining variable optical attenuator perform control such that intensities are equal to each other.

The present invention relates to an excitation means of an optical amplifier.

The present application claims priority on the basis of PCT/JP2022/007892 filed in Japan on Feb. 25, 2022, the contents of which are incorporated herein by reference.

### TECHNICAL FIELD

### Background Art

In designing a high-speed large-capacity optical transmission system, it is important to reduce signal-to-noise (SN) degradation of a received signal caused by a transmission line loss. Therefore, there have been devised various configurations that cause a relay or an optical transmission line itself to perform optical amplification to compensate for the transmission line loss. Among those configurations, an optical amplifier using an erbium-doped fiber as a gain medium has been widely practically used for its simplicity.

Meanwhile, a Raman amplifier using the Raman effect can achieve a wide gain band, and thus adaptation thereof to a wavelength multiplexing transmission system has been actively attempted. In particular, distributed Raman amplification using the optical fiber transmission line itself as a gain medium has a great advantage of using an existing optical fiber as the gain medium, and thus application thereof to next-generation high-speed large-capacity optical communication is expected.

FIG. 10 is a diagram illustrating a configuration example of a conventional optical transmission system 1000 using the distributed Raman amplification. An optical transmission system 1000 illustrated in FIG. 10 includes an optical transmitter 100, an optical receiver 200, a forward pump light generation unit 300, a backward pump light generation unit 400, a forward pump light multiplexing unit 310, and a backward pump light multiplexing unit 410. The optical transmitter 100 and the optical receiver 200 are connected via an optical transmission line 500. Bidirectional pumping is assumed in the optical transmission system 1000. Therefore, in the optical transmission line 500 of the optical transmission system 1000 illustrated in FIG. 10, forward pumping is achieved by pump light output by the forward pump light generation unit 300, and backward pumping is achieved by pump light output by the backward pump light generation unit 400. As a result, an optical signal transmitted from the optical transmitter 100 is amplified and reaches the optical receiver 200.

In the Raman amplification, a wavelength of pump light is shorter than a wavelength of the optical signal by about 0.1 μm. In general, it is necessary for the forward pump light multiplexing unit 310 to multiplex, on the optical signal, pump light traveling in the same direction as the optical signal since the pump light is caused to propagate in a core of the optical transmission line 500 similarly to the optical signal. On the other hand, it is necessary for the backward pump light multiplexing unit 410 to transmit pump light traveling in the direction opposite to the direction of the optical signal to the optical transmission line 500, to demultiplex only the optical signal, and to transmit the optical signal to the optical receiver 200. This multiplexing and demultiplexing can be realized by a wavelength multiplexing coupler or a circulator. Note that, although the bidirectional pumping has been described in FIG. 10, the pump direction may be only forward or only backward.

A gain of the Raman amplification is determined depending on a light intensity of pump light output from a pump light source. Therefore, in order to finely adjust the gain, the adjustment can be achieved by finely adjusting light intensity of the pump light. On the other hand, the gain band of the Raman amplification is determined depending on the wavelength of the pump light output from the pump light source. A semiconductor laser is typically used as the pump light source of the Raman amplification, and adjustment of the light intensity and the wavelength can be achieved by adjusting a pump current and a temperature.

Incidentally, the semiconductor laser used as the pump light source of the Raman amplification is a multi-mode laser in many cases. As an output of the multi-mode laser, light of a plurality of wavelengths rather than a single wavelength is emitted at the same time. The plurality of light beams are called longitudinal modes. The intensity and the wavelength of each longitudinal mode changes due to a change in pump current and temperature. However, a light frequency interval of the longitudinal mode is determined depending on the cavity length of the multi-mode laser, and substantially the same value is thus maintained.

Another factor that determines the gain of the Raman amplification is polarization of the pump light. Since the Raman amplification is an optical effect having polarization dependency, a gain received by the optical signal causes polarization dependency in a case where the pump light is a single polarized wave or in a case where the pump light is not ideally unpolarized although the pump light has been depolarized. In other words, the gain changes depending on a polarization state at the timing when the optical signal is incident on the optical transmission line 500, and a light intensity of the amplified optical signal thus changes. This fluctuation width of the gain is referred to as polarization dependent gain (PDG). The PDG appears particularly remarkably in a configuration having only forward pumping. In backward pumping, the PDG is smaller than that in forward pumping because the signal and pump light propagate in different directions and the polarization changes in the transmission line are very different, but, some means is needed to completely curb the PDG.

As one means for curbing the PDG, outputs of an even number of multi-mode lasers are polarization-multiplexed inside the forward pump light generation unit 300 or the backward pump light generation unit 400 to achieve an unpolarized state. FIG. 11 is a diagram illustrating a configuration example of a case where two multi-mode lasers are included inside the forward pump light generation unit 300 or the backward pump light generation unit 400. FIG. 11 illustrates, as an example, a case where two multi-mode lasers are included inside the forward pump light generation unit 300. Note that the configuration illustrated in FIG. 11 may be included inside the backward pump light generation unit 400.

The forward pump light generation unit 300 includes a first multi-mode laser 10, a second multi-mode laser 11, a first pump current/temperature controller 12, a second pump current/temperature controller 13, a first polarization maintaining optical waveguide 14, a second polarization maintaining optical waveguide 15, and a polarization beam combiner (PBC) 16. The wavelengths and the light intensities of the first multi-mode laser 10 and the second multi-mode laser 11 are controlled by the first pump current/temperature controller 12 and the second pump current/temperature controller 13, respectively. The first multi-mode laser 10 outputs first pump light having a wavelength and a light intensity controlled by the first pump current/temperature controller 12. The second multi-mode laser 11 outputs second pump light having a wavelength and a light intensity controlled by the second pump current/temperature controller 13.

The first pump light output from the first multi-mode laser 10 is propagated through the first polarization maintaining optical waveguide 14 and is input to the PBC 16. Moreover, the second pump light output from the second multi-mode laser 11 is propagated through the second polarization maintaining optical waveguide 15 and is input to the PBC 16. The PBC 16 polarization-multiplexes the input first pump light and second pump light and outputs unpolarized pump light.

Note that it is also possible to use a depolarizer based on a passive optical circuit described in Non Patent Literature 1 as another means for curbing the PDG. Specific description will be omitted here.

Here, the following three conditions occur for the first pump light and the second pump light in order to stably perform the Raman amplification.

### First Condition

The center wavelengths of the first pump light and the second pump light should be substantially the same.

### Second Condition

The light intensities of the first pump light and the second pump light should be the same.

### Third Condition

The longitudinal modes of the first pump light and the longitudinal modes of the second pump light should be arranged such that they do not overlap each other.

The reason that the first condition has to be satisfied is that polarization rotation occurs due to slight anisotropy of the optical transmission line 500 in a process in which the first pump light and the second pump light are propagated through the optical transmission line 500, and it is not possible to hold polarization orthogonality of both the first pump light and the second pump light if the center wavelengths thereof are different from each other since the polarization rotation has wavelength dependency. The reason that the second condition has to be satisfied is that PDG occurs if the light intensities of the first pump light and the second pump light are different from each other. The reason that the third condition has to be satisfied is that large noise may be superimposed on light amplified by the Raman amplification if the longitudinal modes of the first pump light and the longitudinal modes of the second pump light overlap each other (see Non Patent Literature 2, for example). Although the cause of the occurrence of the noise can be explained by fluctuation of synthesized polarization discussed in Non Patent Literature 1, detailed description will be omitted here. In order to curb occurrence of the noise, Non Patent Literature 2 illustrates that it is necessary to alternately arrange each of the longitudinal modes that the first multi-mode laser 10 and the second multi-mode laser 11 have as illustrated in FIG. 12.

FIG. 12 is a schematic view of an optical spectrum output from each of the first multi-mode laser 10 and the second multi-mode laser 11. In FIG. 12, light frequencies of the longitudinal modes output from the first multi-mode laser 10 are expressed as f_{1_1}, f_{1_2}, . . . f_{1_5}. Similarly, in FIG. 12, light frequencies of the longitudinal modes output from the second multi-mode laser 11 are expressed as f_{2_1}, f_{2_2}, . . . f_{2_5}.

### CITATION LIST

### Non Patent Literature

Non Patent Literature 1: Hiroto Kawakami, et al., “Suppression of Intensity Noises in Forward-pumped Raman Amplifier Utilizing Depolarizer for Multiple Pump Laser Sources,” J. Lightw. Technol., Vol. 39, PP. 7417-7426, 2021.
Non Patent Literature 2: Catherine Martinelli et al., “RIN Transfer in Copumped Raman Amplifiers Using Polarization-Combined Diodes,” Photonics. Technol. Lett., Vol. 17, PP. 1836-1838, 2005.

### SUMMARY OF INVENTION

### Technical Problem

However, the conventional configuration illustrated in FIG. 11 has problems as will be described below. The light frequency and the intensity of each longitudinal mode of the multi-mode laser have to satisfy the three conditions described above. It is relatively easy to satisfy one or two of the three conditions by selecting a laser and adjusting the pump current and the temperature. However, the adjustment of the pump current and the temperature may affect both the light frequency and the intensity of each longitudinal mode, and it is thus difficult to satisfy all three of the above conditions at the same time. Even if all three conditions can be satisfied, there is a need to retry the fine adjustment in a case where it is necessary to change the gain of the Raman amplification.

Furthermore, another problem is that when the longitudinal modes are arranged alternately, the plurality of longitudinal modes of the pump light and the signal light mix into four optical signals (four-wave mixing) within the optical transmission line 500, which causes signal deterioration. Although the optical signal and the pump light are separated from each other by 0.1 μm as described above, and the four-wave mixing occurring at the wavelength intervals separated this much can be ignored in general, there is a problem that influences thereof on quality of the signals cannot be ignored in the Raman application since the pump light used therefor typically has significantly high power.

In view of the above circumstances, an object of the present invention is to provide a technique capable of curbing degradation of signal quality of an amplified optical signal when Raman amplification is performed with pump light obtained by polarization-multiplexing outputs of an even number of multi-mode lasers.

### Solution to Problem

An aspect of the present invention is a pump light generation device including: a first multi-mode laser that outputs first pump light; a second multi-mode laser that outputs second pump light; a first pump current/temperature controller that controls a temperature and a pump current of the first multi-mode laser; a second pump current/temperature controller that controls a temperature and a pump current of the second multi-mode laser; a first polarization maintaining variable optical attenuator that receives the first pump light as an input, adjusts a light intensity of the first pump light while keeping a polarization state thereof in a linearly polarized wave, and outputs the first pump light; a second polarization maintaining variable optical attenuator that receives the second pump light as an input, adjusts a light intensity of the second pump light while keeping a polarization state thereof in a linearly polarized wave, and outputs the second pump light; and a polarization multiplexing circuit that polarization-multiplexes and outputs the first pump light with the light intensity adjusted by the first polarization maintaining variable optical attenuator and the second pump light with the light intensity adjusted by the second polarization maintaining variable optical attenuator, in which the first pump current/temperature controller and the second pump current/temperature controller control at least either pump currents or temperatures of the first multi-mode laser and the second multi-mode laser such that the longitudinal modes included in the first pump light and the longitudinal modes included in the second pump light do not overlap each other, and the first polarization maintaining variable optical attenuator and the second polarization maintaining variable optical attenuator perform control such that intensities of the first pump light and the second pump light are equal to each other.

An aspect of the present invention is a pump light generation device including: a first multi-mode laser that outputs first pump light; a second multi-mode laser that outputs second pump light; a first pump current/temperature controller that controls a temperature and a pump current of the first multi-mode laser; a second pump current/temperature controller that controls a temperature and a pump current of the second multi-mode laser; a first polarization maintaining optical amplifier that receives the first pump light as an input, amplifies a light intensity of the first pump light while keeping a polarization state thereof in a linearly polarized wave, and outputs the first pump light; a second polarization maintaining optical amplifier that receives the second pump light as an input, amplifies a light intensity of the second pump light while keeping a polarization state thereof in a linearly polarized wave, and outputs the second pump light; and a polarization multiplexing circuit that polarization-multiplexes and outputs the first pump light with the light intensity amplified by the first polarization maintaining optical amplifier and the second pump light with the light intensity amplified by the second polarization maintaining optical amplifier, in which the first pump current/temperature controller and the second pump current/temperature controller control at least either pump currents or temperatures of the first multi-mode laser and the second multi-mode laser such that longitudinal modes included in the first pump light and longitudinal modes included in the second pump light do not overlap each other, and the first polarization maintaining optical amplifier and the second polarization maintaining optical amplifier perform control such that the intensities of the first pump light and the second pump light are equal to each other.

An aspect of the present invention is an optical amplification device including: a first multi-mode laser that outputs first pump light with longitudinal mode frequency intervals of δf₁; a second multi-mode laser that outputs second pump light with longitudinal mode frequency intervals of δf₂; a first pump current/temperature controller that controls a temperature and a pump current of the first multi-mode laser; a second pump current/temperature controller that controls a temperature and a pump current of the second multi-mode laser; a polarization multiplexing circuit that polarization-multiplexes and outputs the first pump light and the second pump light; and a gain medium, to which all of an optical signal and the first pump light and the second pump light output from the polarization multiplexing circuit are input, the gain medium amplifying and then outputting the optical signal, in which the first pump current/temperature controller and the second pump current/temperature controller control at least either pump currents or temperatures of the first multi-mode laser and the second multi-mode laser such that longitudinal modes included in the first pump light and longitudinal modes included in the second pump light do not overlap each other, and in a case where the optical signal amplified by the first pump light and the second pump light is a digital signal of a baud rate f_{R}, the frequency intervals δf₁ and δf₂ of the longitudinal modes are greater than the baud rate f_{B}.

An aspect of the present invention is a pump light generation method including: by a first multi-mode laser, outputting first pump light; by a second multi-mode laser, outputting second pump light; by a first pump current/temperature controller, controlling a temperature and a pump current of the first multi-mode laser; by a second pump current/temperature controller, controlling a temperature and a pump current of the second multi-mode laser; by a first light intensity changing unit, receiving the first pump light as an input, changing a light intensity of the first pump light while keeping a polarization state thereof in a linearly polarized wave, and outputting the first pump light; by a second light intensity changing unit, receiving the second pump light as an input, changing a light intensity of the second pump light while keeping a polarization state thereof in a linearly polarized wave, and outputting the second pump light; by a polarization multiplexing circuit, polarization-multiplexing and outputting the first pump light with the light intensity changed by the first light intensity changing unit and the second pump light with the light intensity changed by the second light intensity changing unit; by the first pump current/temperature controller and the second pump current/temperature controller, controlling at least either pump currents or temperatures of the first multi-mode laser and the second multi-mode laser such that longitudinal modes included in the first pump light and longitudinal modes included in the second pump light do not overlap each other, and by the first light intensity changing unit and the second light intensity changing unit, performing control such that intensities of the first pump light and the second pump light are equal to each other.

### Advantageous Effects of Invention

According to the present invention, it is possible to curb degradation of signal quality of an amplified optical signal when Raman amplification is performed with pump light obtained by polarization-multiplexing outputs of an even number of multi-mode lasers.

### BRIEF DESCRIPTION OF DRAWINGS

FIG. 1 A diagram illustrating a configuration example of a pump light generation unit according to a first embodiment.

FIG. 2 A schematic view of arrangement of longitudinal modes of first pump light and second pump light.

FIG. 3 A schematic view of another example of arrangement of longitudinal modes of the first pump light and the second pump light.

FIG. 4 A flowchart illustrating a flow of processing of the pump light generation unit according to the first embodiment.

FIG. 5 A diagram illustrating a configuration example of a pump light generation unit according to a modification example of the first embodiment.

FIG. 6 A diagram illustrating a configuration example of a pump light generation unit according to a second embodiment.

FIG. 7 A diagram illustrating a configuration example of a pump light generation unit according to a third embodiment.

FIG. 8 A diagram illustrating a configuration example of an optical amplifier according to a fourth embodiment.

FIG. 9 A diagram illustrating a configuration example of an optical amplifier according to a modification example of the fourth embodiment.

FIG. 10 A diagram illustrating a configuration example of a conventional optical transmission system using distributed Raman amplification.

FIG. 11 A diagram illustrating a configuration example of a case where two multi-mode lasers are included inside a forward pump light generation unit or a backward pump light generation unit.

FIG. 12 A schematic view of an optical spectrum output from each of a first multi-mode laser and a second multi-mode laser.

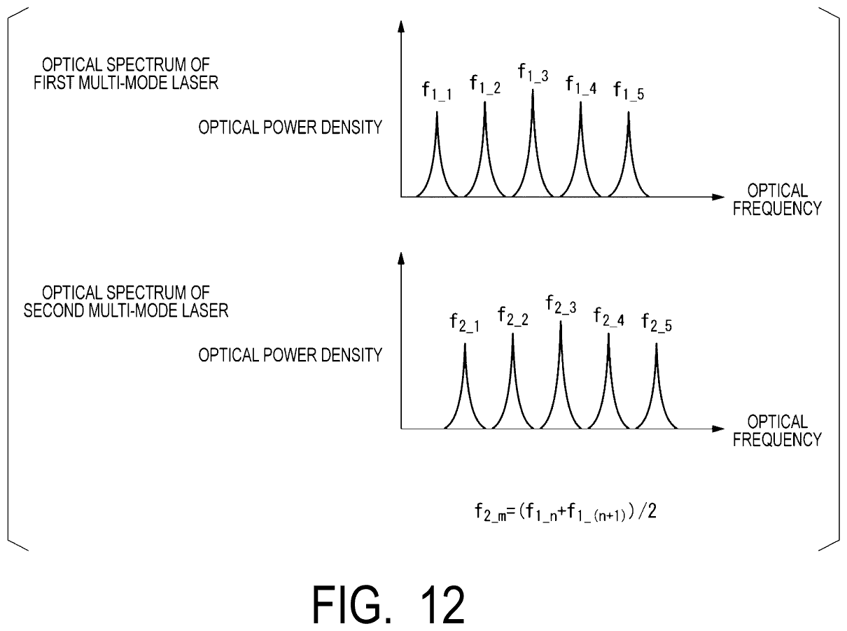

### DESCRIPTION OF EMBODIMENTS

Hereinafter, an embodiment of the present invention will be described with reference to drawings.

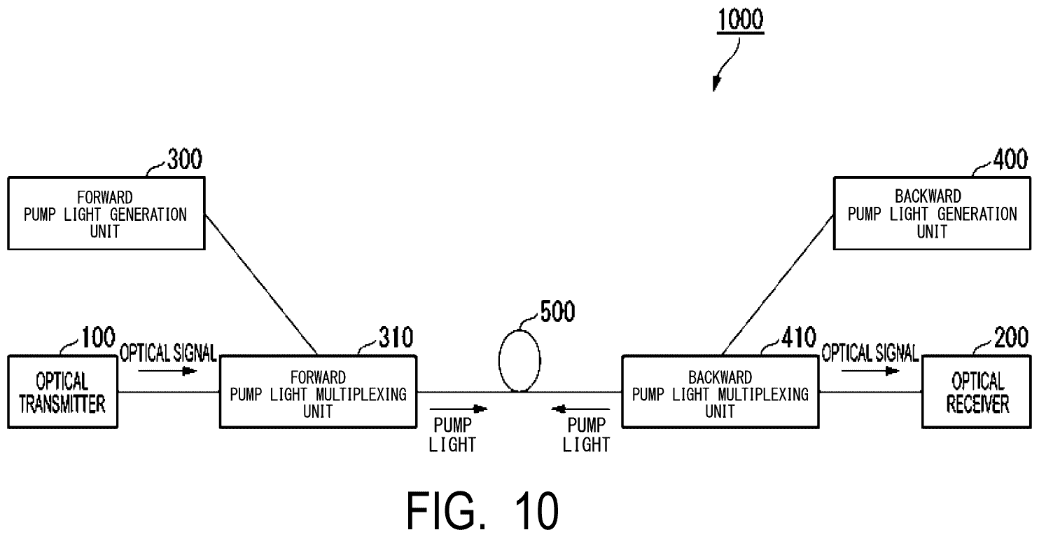

A system configuration of an optical transmission system according to the present invention is similar to a system configuration illustrated in FIG. 10. A difference from the conventional optical transmission system is an internal configuration of a forward pump light generation unit 300 or a backward pump light generation unit 400. Thus, characteristic configurations of the present invention will be explained in the following description.

### First Embodiment

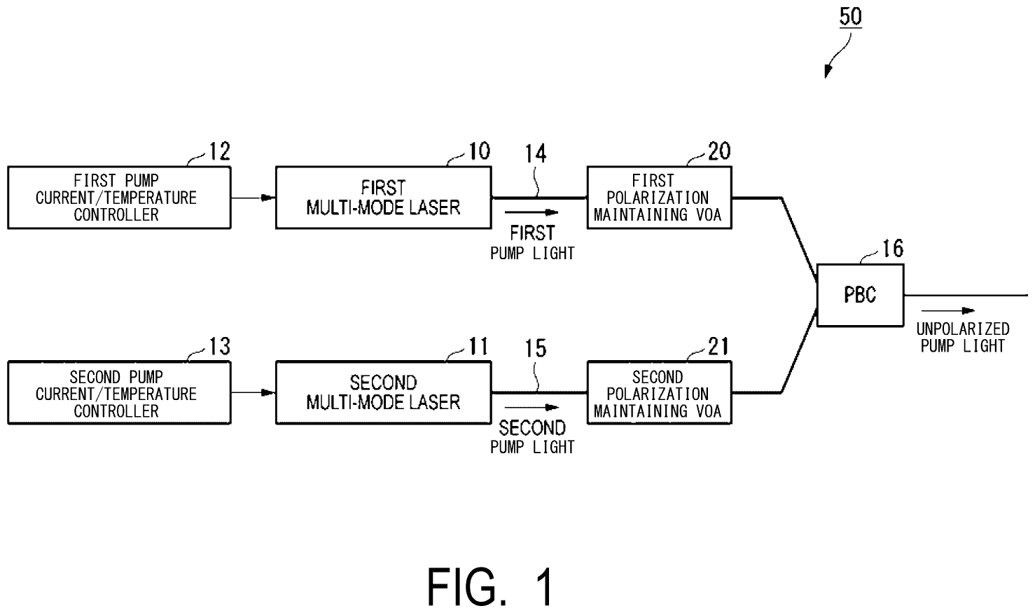

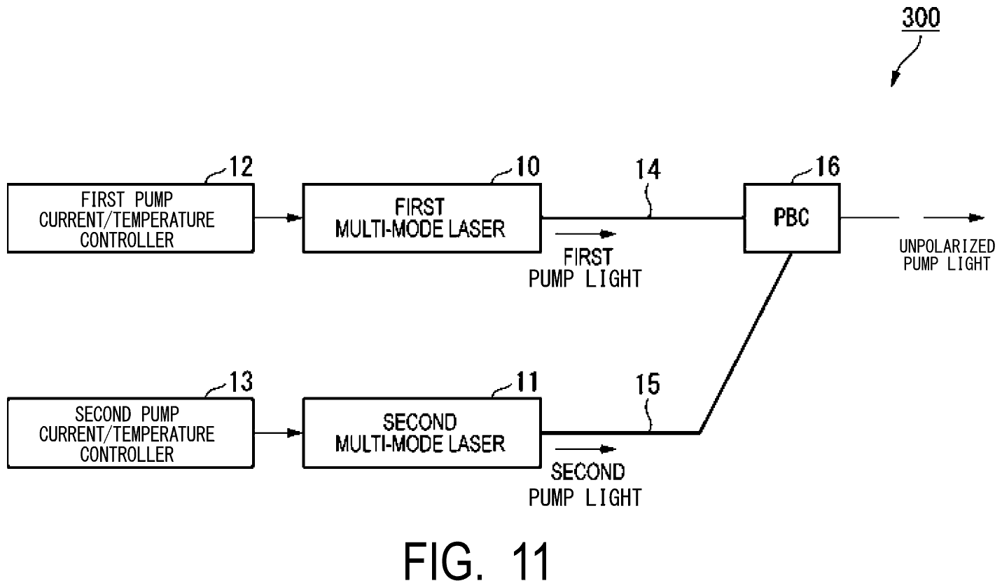

FIG. 1 is a diagram illustrating a configuration example of a pump light generation unit 50 according to a first embodiment. The pump light generation unit 50 is any of a forward pump light generation unit 300 or a backward pump light generation unit 400. The pump light generation unit 50 is an aspect of the pump light generation device. In the pump light generation unit 50 illustrated in FIG. 1, components that are common to the configurations illustrated in FIG. 11 are denoted by the same numbers.

The pump light generation unit 50 includes a first multi-mode laser 10, a second multi-mode laser 11, a first pump current/temperature controller 12, a second pump current/temperature controller 13, a first polarization maintaining optical waveguide 14, a second polarization maintaining optical waveguide 15, a PBC 16, a first polarization maintaining variable optical attenuator (VOA) 20, and a second polarization maintaining VOA 21.

The wavelengths and the light intensities of the first multi-mode laser 10 and the second multi-mode laser 11 are controlled by the first pump current/temperature controller 12 and the second pump current/temperature controller 13, respectively. The first multi-mode laser 10 outputs first pump light having a wavelength and a light intensity controlled by the first pump current/temperature controller 12. The second multi-mode laser 11 outputs second pump light having a wavelength and a light intensity controlled by the second pump current/temperature controller 13. The first multi-mode laser 10 and the second multi-mode laser 11 output substantially the same wavelength.

The first pump current/temperature controller 12 controls the first multi-mode laser 10. Specifically, the first pump current/temperature controller 12 performs control such that the cavity length of the first multi-mode laser 10 becomes the same as the cavity length of the second multi-mode laser 11 and the pump current and the temperature of the first multi-mode laser 10 become substantially the same as the pump current and the temperature of the second multi-mode laser 11. Note that the first pump current/temperature controller 12 may control at least either the pump current or the temperature of the first multi-mode laser 10.

The second pump current/temperature controller 13 controls the second multi-mode laser 11. Specifically, the second pump current/temperature controller 13 performs control such that the cavity length of the second multi-mode laser 11 becomes the same as the cavity length of the first multi-mode laser 10 and the pump current and the temperature of the second multi-mode laser 11 become substantially the same as the pump current and the temperature of the first multi-mode laser 10. Note that the second pump current/temperature controller 13 may control at least either the pump current or the temperature of the second multi-mode laser 11.

The first condition (the center wavelengths of the first pump light and the second pump light have to be substantially the same) from among the three conditions to stably perform the Raman amplification can be relatively easily realized by setting the same cavity lengths of the first multi-mode laser 10 and the second multi-mode laser 11 and setting substantially the same pump currents and the temperatures of the first multi-mode laser 10 and the second multi-mode laser 11 by the first pump current/temperature controller 12 and the second pump current/temperature controller 13.

Next, the third condition (the longitudinal modes of the first pump light and the longitudinal modes of the second pump light have to be arranged such that they do not overlap each other) from among the three conditions can be realized by the first pump current/temperature controller 12 and the second pump current/temperature controller 13 slightly differentiating the temperatures of the first multi-mode laser 10 and the second multi-mode laser 11. Each of the pump currents and the temperatures obtained in the above description is fixed and is not changed through the following fine adjustment.

The first polarization maintaining VOA 20 is disposed in the first polarization maintaining optical waveguide 14 and adjusts light intensity of the first pump light output from the first multi-mode laser 10. The first polarization maintaining VOA 20 is an aspect of the first light intensity changing unit.

The second polarization maintaining VOA 21 is disposed in the second polarization maintaining optical waveguide 15 and adjusts light intensity of the second pump light output from the second multi-mode laser 11. The second polarization maintaining VOA 21 is an aspect of the second light intensity changing unit.

The second condition (the light intensities of the first pump light and the second pump light should be the same) from among the three conditions is realized by finely adjusting the first polarization maintaining VOA 20 and the second polarization maintaining VOA 21. The first polarization maintaining VOA 20 and the second polarization maintaining VOA 21 changes only the light intensities of the pump light and do not affect the light frequency of each longitudinal mode, and the first condition and the third condition are still satisfied as described above.

However, a higher gain of the Raman amplification is not necessarily better. An excessively high gain may lead to a nonlinear optical effect of the optical signal and cause degradation of signal quality. In order to avoid such a situation, it is necessary to lower the intensity of the pump light. In this case, the light intensity of the pump light is adjusted by changing the first polarization maintaining VOA 20 and the second polarization maintaining VOA 21 simultaneously instead of changing the pump current which is often performed in the conventional art, and increasing a light loss by the same amount.

The PBC 16 polarization-multiplexes the first pump light with light intensity adjusted by the first polarization maintaining VOA 20 and the second pump light with light intensity adjusted by the second polarization maintaining VOA 21 and outputs unpolarized pump light. The PBC 16 is an aspect of the polarization multiplexing circuit.

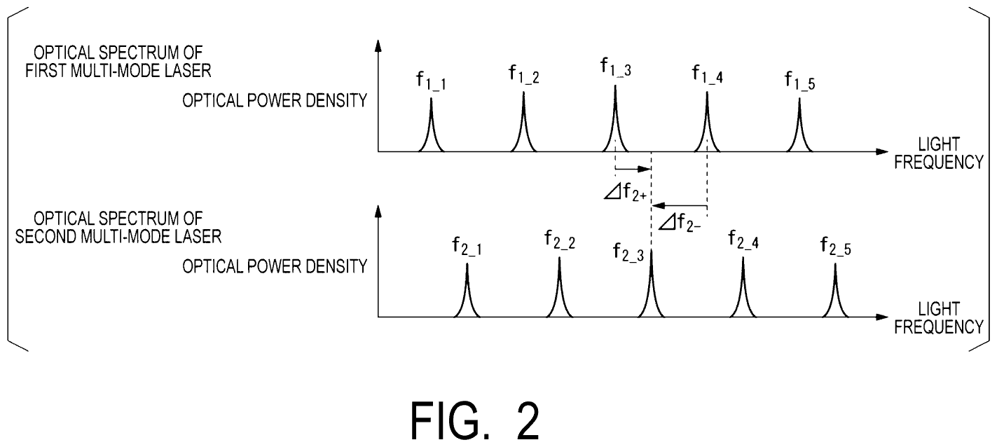

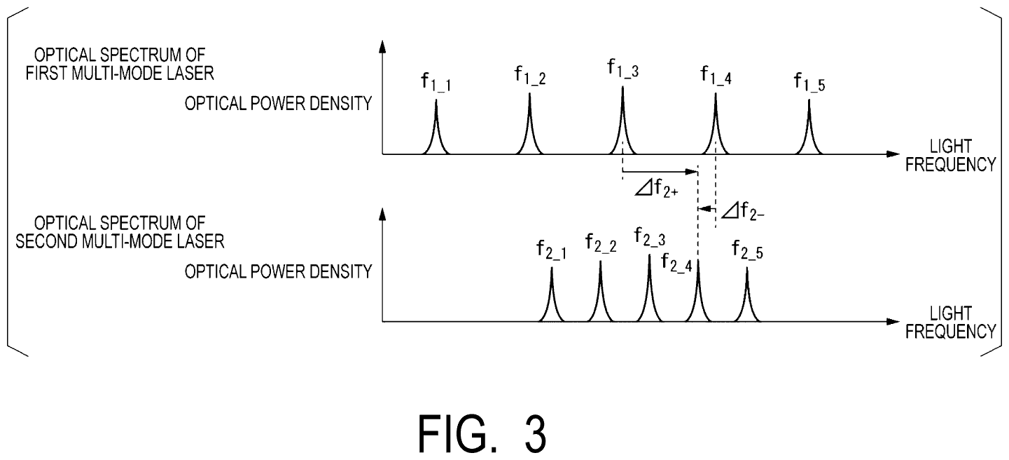

Next, arrangement of the longitudinal modes of the first pump light and the second pump light will be described with reference to FIGS. 2 and 3. FIG. 2 is a schematic diagram of arrangement of the longitudinal modes of the first pump light and the second pump light to be achieved by the first pump current/temperature controller 12 and the second pump current/temperature controller 13. Similarly to FIG. 10, the light frequencies of the longitudinal mode output from the first multi-mode laser 10 are denoted as f_{1_1}, f_{1_2}, . . . , and f_{1_5}, and the light frequencies of the longitudinal mode output from the second multi-mode laser 11 are denoted as f_{2_1}, f_{2_2}, . . . , and f_{2_5}.

First, attention is paid to any one of the longitudinal modes. In FIG. 2, the light frequency f_{2_3} is selected from the output of the second multi-mode laser 11. Next, a longitudinal mode that is greater than the light frequency f_{2_3} and is the closest to the light frequency f_{2_3} and a longitudinal mode that is smaller than the light frequency f_{2_3} and is the closest to the light frequency f_{2_3} are searched for from outputs of the first multi-mode laser 10. In FIG. 2, the light frequency f_{1_4} and the light frequency f_{1_3} correspond thereto.

Here, when the light frequency f_{2_3}-f_{1_3} is denoted as Δf₂₊, and the light frequency f_{2_3}-f_{1_4} is denoted as Δf₂₋, each longitudinal mode is set such that |Δf₂₊| and |Δf₂₋| are not equal to each other in the present embodiment. Although the description has been provided by focusing on the light frequency f_{2_3} here, setting is made such that |Δf₂₊| and |Δf₂₋| are not equal to each other even if attention is paid to any longitudinal mode other than the light frequency f_{2_3}.

For the above conditions, the setting has to be made such that |Δf₁₊| and |Δf₁₋| are not equal to each other in a similar manner even in a case where Δf₁₊ and Δf₁₋ are defined with the first multi-mode laser 10 and the second multi-mode laser 11 replaced with each other. Such setting causes light occurring in four-wave mixing to be located at non-equal intervals and can thus disperse optical noise.

### (Another Example of Arrangement of Longitudinal Modes of First Pump Light and Second Pump Light)

Description has been given on the assumption that the longitudinal mode intervals of the outputs of the first multi-mode laser 10 and the longitudinal mode intervals of the outputs of the second multi-mode laser 11 are equal to each other in FIG. 2. Next, a case wherein the longitudinal mode intervals of the outputs of the first multi-mode laser 10 are wider than the longitudinal mode intervals of the outputs of the second multi-mode laser 11 will be descried by using FIG. 3. Although FIG. 3 is illustrated by selecting the light frequency f_{2_4} from the outputs of the second multi-mode laser 11, the first pump current/temperature controller 12 and the second pump current/temperature controller 13 control the first multi-mode laser 10 and the second multi-mode laser 11 such that |Δf₂₊| and |Δf₂₋| are not equal to each other.

Here, the light frequency f_{2_4} is selected as a reference, and f₂₊ and f₂₋ are illustrated in FIG. 3. However, in a case where |Δf₂₊| and |Δf₂₋| are obtained with reference to f_{2_3}, |Δf₂₊| decreases while |Δf₂₋| increases as compared with a case where the light frequency f_{2_4} is used as a reference. In the present embodiment, the arrangement of the longitudinal modes is selected such that |Δf₂₊| and |Δf₂₋| are not equal to each other or to minimize the number of combinations by which |Δf₂₊| and |Δf₂₋| are equal to each other regardless of which of the longitudinal modes is selected.

Incidentally, each of the total number of the longitudinal modes output from the first multi-mode laser 10 and the total number of the longitudinal modes output from the second multi-mode laser 11 is set to 5 in FIGS. 2 and 3. However, a considerably large number of longitudinal modes are generated by actual multi-mode lasers, particularly multi-mode lasers that do not use fiber Bragg grating. Therefore, it is very difficult to perform setting such that |Δf₂₊| and |Δf₂₋| are always different values in a case where the longitudinal mode intervals of the outputs of the first multi-mode laser 10 and the longitudinal mode intervals of the outputs of the second multi-mode laser 11 are not equal to each other.

In such a case, a constant R that satisfies 0<R<1 may be defined in advance, and the conditions may be relaxed such that |Δf₂₊| and |Δf₂₋| are allowed to be equal to each other in regard to the longitudinal modes of the outputs of the second multi-mode laser 11 having the optical power that is lower than P_{2_max}×R when the maximum optical power from among the light frequencies f_{2_1}, f_{2_2}, . . . is denoted as P_{2_max}, and |Δf₁₊| and |Δf₁₋| are allowed to be equal to each other in regard to the longitudinal modes of the outputs of the first multi-mode laser 10 having an optical power that is lower than P_{1_max}×R when the maximum optical power from among f_{1_1}, f_{1_2}, . . . is denoted as P_{1_max}. Although how to set the R value here depends on spectra of the multi-mode lasers and is thus not obvious, the R value may be selected to minimize relative intensity noise (RIN) of the Raman-amplified light according to one policy. Alternatively, an optical band pass filter may be placed at the output of the PBC 16, the longitudinal modes around the first multi-mode laser 10 and the second multi-mode laser 11 may be suppressed, and the number of longitudinal modes may thus be reduced, as a simpler method.

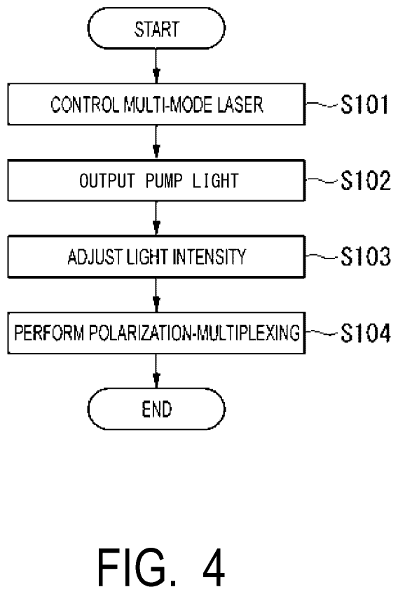

FIG. 4 is a flowchart illustrating a flow of processing of the pump light generation unit 50 according to the first embodiment.

The first pump current/temperature controller 12 and the second pump current/temperature controller 13 control the first multi-mode laser 10 and the second multi-mode laser 11 (Step S101). Specifically, the first pump current/temperature controller 12 performs control such that the cavity length of the first multi-mode laser 10 becomes the same and the pump current and the temperature of the first multi-mode laser 10 become substantially the same as the pump current and the temperature of the second multi-mode laser 11. Specifically, the second pump current/temperature controller 13 performs control such that the cavity length of the second multi-mode laser 11 becomes the same and the pump current and the temperature of the second multi-mode laser 11 become substantially the same as the pump current and the temperature of the first multi-mode laser 10.

The first multi-mode laser 10 and the second multi-mode laser 11 output pump light (Step S102). Specifically, the first multi-mode laser 10 is controlled by the first pump current/temperature controller 12 and then outputs first pump light to the first polarization maintaining optical waveguide 14. The second multi-mode laser 11 is controlled by the second pump current/temperature controller 13 and then outputs second pump light to the second polarization maintaining optical waveguide 15.

The first pump light transmitted through the first polarization maintaining optical waveguide 14 is input to the first polarization maintaining VOA 20. The second pump light transmitted through the second polarization maintaining optical waveguide 15 is input to the second polarization maintaining VOA 21. The first polarization maintaining VOA 20 and the second polarization maintaining VOA 21 adjust the light intensity of the input pump light (Step S103). Specifically, the first polarization maintaining VOA 20 adjusts the light intensity of the input first pump light, and the second polarization maintaining VOA 21 adjusts the light intensity of the input second pump light. In order to satisfy the second condition, the first polarization maintaining VOA 20 and the second polarization maintaining VOA 21 perform adjustment such that the light intensity of the first pump light and the light intensity of the second pump light become the same light intensity.

The first polarization maintaining VOA 20 outputs the first pump light with the adjusted light intensity to the PBC 16. The second polarization maintaining VOA 21 outputs the second pump light with the adjusted light intensity to the PBC 16. The PBC 16 polarization-multiplexes the first pump light with the light intensity adjusted by the first polarization maintaining VOA 20 and the second pump light with the light intensity adjusted by the second polarization maintaining VOA 21 (Step S104). In this manner, the PBC 16 generates the unpolarized pump light. The PBC 16 outputs the unpolarized pump light.

According to the pump light generation unit 50 configured as described above, it is possible to curb degradation of signal quality of the amplified optical signal when the Raman amplification is performed with the pump light obtained by polarization-multiplexing the outputs of the even number of multi-mode lasers. Specifically, it is necessary to satisfy all the three conditions to stably perform the Raman amplification, the pump light generation unit 50 can satisfy the first condition and the third condition through the control of the first pump current/temperature controller 12 and the second pump current/temperature controller 13 and can satisfy the second condition through the adjustment of the light intensity performed by the first polarization maintaining VOA 20 and the second polarization maintaining VOA 21. As a result, it is possible to curb degradation of signal quality of the amplified optical signal.

### Modification Example 1 of First Embodiment

In the above embodiment, it is possible to omit the second polarization maintaining VOA 21 (or the first polarization maintaining VOA 20) from the configuration of the pump light generation unit 50 in a case where it is known that the light intensity of the outputs of the first multi-mode laser 10 is always higher (or lower) than the light intensity of the outputs of the second multi-mode laser 11 at the point when the first and second conditions are satisfied from among the three conditions. However, it is not easy to change the light intensity of the pump light after the polarization multiplexing in this case.

### Modification Example 2 of First Embodiment

The first pump current/temperature controller 12 and the second pump current/temperature controller 13 may be configured to control at least either the pump currents or the temperatures of the first multi-mode laser 10 and the second multi-mode laser 11 such that the longitudinal modes included in the first pump light and the longitudinal modes included in the second pump light do not overlap and the first pump light has higher power than the second pump light.

### Modification Example 3 of First Embodiment

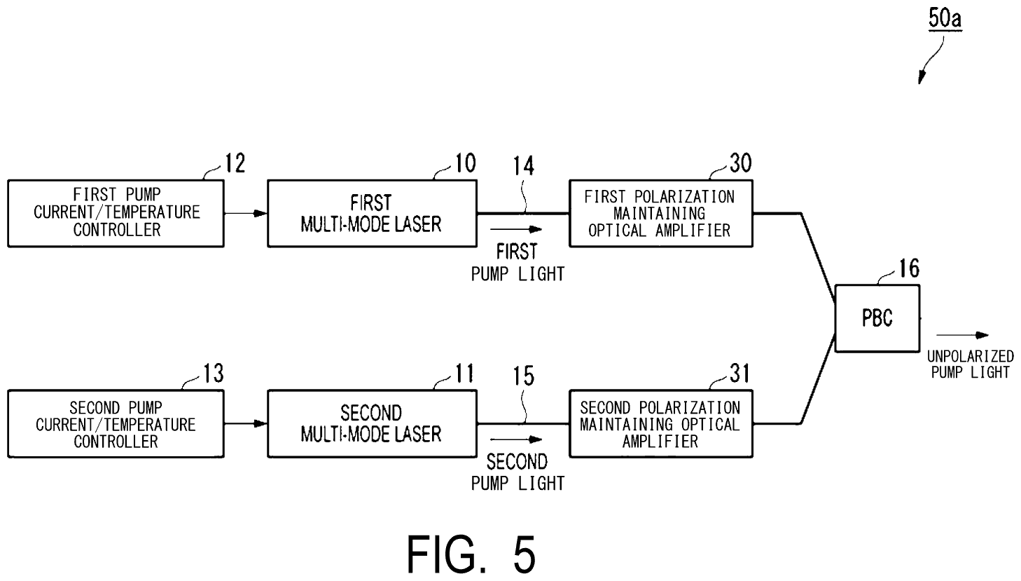

The pump light generation unit 50 may be changed to the configuration illustrated in FIG. 3. FIG. 5 is a diagram illustrating a configuration example of a pump light generation unit 50a according to a modification example of the first embodiment. The pump light generation unit 50a is either the forward pump light generation unit 300 or the backward pump light generation unit 400. The pump light generation unit 50a is an aspect of the pump light generation device. In the pump light generation unit 50a illustrated in FIG. 5, the same reference signs are applied to components that are common to those of the configuration illustrated in FIG. 1.

The pump light generation unit 50a includes a first multi-mode laser 10, a second multi-mode laser 11, a first pump current/temperature controller 12, a second pump current/temperature controller 13, a first polarization maintaining optical waveguide 14, a second polarization maintaining optical waveguide 15, a PBC 16, a first polarization maintaining optical amplifier 30, and a second polarization maintaining optical amplifier 31.

The pump light generation unit 50a has a configuration that is different from that of the pump light generation unit 50 in that the pump light generation unit 50a includes the first polarization maintaining optical amplifier 30 and the second polarization maintaining optical amplifier 31 instead of the first polarization maintaining VOA 20 and the second polarization maintaining VOA 21. Hereinafter, differences from the pump light generation unit 50 will be described.

The first polarization maintaining optical amplifier 30 adjusts the light intensity of the first pump light. The second polarization maintaining optical amplifier 31 adjusts the light intensity of the second pump light. In order to satisfy the second condition, the first polarization maintaining optical amplifier 30 and the second polarization maintaining optical amplifier 31 perform adjustment such that the light intensity of the first pump light and the light intensity of the second pump light become the same light intensity. As the first polarization maintaining optical amplifier 30 and the second polarization maintaining optical amplifier 31, it is possible to use semiconductor optical amplifiers, for example.

The intensities of the first pump light and the second pump light can become the same through fine adjustment of any one of the gains of the first polarization maintaining optical amplifier 30 and the second polarization maintaining optical amplifier 31. It is possible to change the intensity of the pump light after the polarization multiplexing by adjusting both the gains of the first polarization maintaining optical amplifier 30 and the second polarization maintaining optical amplifier 31. Although it is technically difficult to design a high-power laser in general, it is possible to ease specifications of the first multi-mode laser 10 and the second multi-mode laser 11 since the first polarization maintaining optical amplifier 30 and the second polarization maintaining optical amplifier 31 amplify the pump light in the embodiment. Since the first and second polarization maintaining VOAs that may serve as loss media are not present unlike the aforementioned embodiment, it is possible to minimize a loss of the pump light.

### Second Embodiment

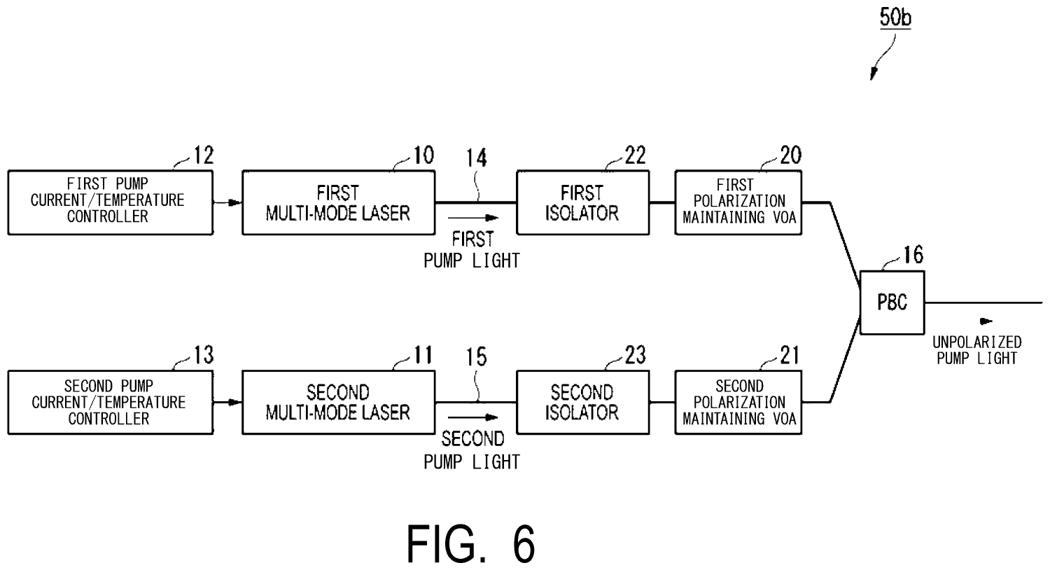

FIG. 6 is a diagram illustrating a configuration of a pump light generation unit 50b according to a second embodiment. The pump light generation unit 50b is any of the forward pump light generation unit 300 or the backward pump light generation unit 400. The pump light generation unit 50b is an aspect of the pump light generation device. In the pump light generation unit 50b illustrated in FIG. 6, the same reference signs are applied to components that are common to the configurations illustrated in FIG. 1.

The pump light generation unit 50b includes a first multi-mode laser 10, a second multi-mode laser 11, a first pump current/temperature controller 12, a second pump current/temperature controller 13, a first polarization maintaining optical waveguide 14, a second polarization maintaining optical waveguide 15, a PBC 16, a first polarization maintaining VOA 20, a second polarization maintaining VOA 21, a first isolator 22, and a second isolator 23.

The pump light generation unit 50b has a configuration that is different from that of the pump light generation unit 50 in that the pump light generation unit 50b further includes the first isolator 22 and the second isolator 23. Hereinafter, differences from the pump light generation unit 50 will be described.

The first isolator 22 is provided between the first multi-mode laser 10 and the first polarization maintaining VOA 20 and blocks an input of reflected light from the first polarization maintaining VOA 20. In this manner, the first isolator 22 prevents an input of the reflected light from the first polarization maintaining VOA 20 to the first multi-mode laser 10. The first isolator 22 is an aspect of the first light intensity changing unit.

The second isolator 23 is provided between the second multi-mode laser 11 and the second polarization maintaining VOA 21 and blocks an input of reflected light from the second polarization maintaining VOA 21. In this manner, the second isolator 23 prevents an input of the reflected light from the second polarization maintaining VOA 21 to the second multi-mode laser 11. The second isolator 23 is an aspect of the second light intensity changing unit.

It is difficult to completely eliminate light reflection from the first polarization maintaining VOA 20 and the second polarization maintaining VOA 21 due to a problem in terms of the configuration of the optical circuit, and it is known that an output of a semiconductor laser may become unstable due to reflected light flowing backward from the outside. It is possible to enhance levels of stability of the first multi-mode laser 10 and the second multi-mode laser 11 by blocking the reflected light with the first isolator 22 and the second isolator 23.

### Modification Example 1 of Second Embodiment

The pump light generation unit 50b may be configured to include the first polarization maintaining optical amplifier 30 and the second polarization maintaining optical amplifier 31 instead of the first polarization maintaining VOA 20 and the second polarization maintaining VOA 21 similarly to the first embodiment.

### Third Embodiment

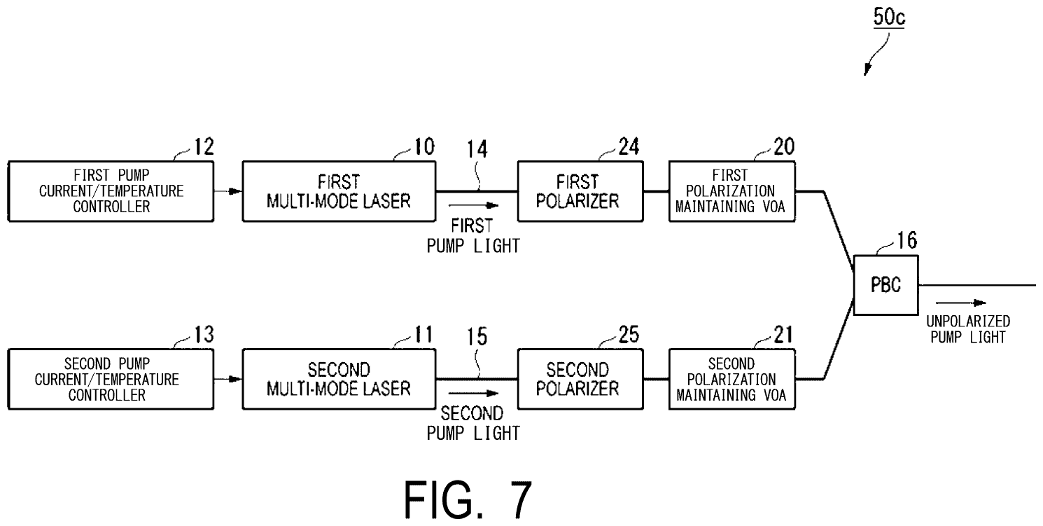

FIG. 7 is a diagram illustrating a configuration of a pump light generation unit 50c according to a third embodiment. The pump light generation unit 50c is either the forward pump light generation unit 300 or the backward pump light generation unit 400. The pump light generation unit 50c is an aspect of the pump light generation device. In the pump light generation unit 50c illustrated in FIG. 7, the same reference signs are applied to components that are common to those illustrated in FIG. 1.

The pump light generation unit 50c includes a first multi-mode laser 10, a second multi-mode laser 11, a first pump current/temperature controller 12, a second pump current/temperature controller 13, a first polarization maintaining optical waveguide 14, a second polarization maintaining optical waveguide 15, a PBC 16, a first polarization maintaining VOA 20, a second polarization maintaining VOA 21, a first polarizer 24, and a second polarizer 25.

The pump light generation unit 50c has a configuration that is different from that of the pump light generation unit 50 in that the pump light generation unit 50c further includes the first polarizer 24 and the second polarizer 25. Hereinafter, differences from the pump light generation unit 50 will be described.

The first polarizer 24 is provided between the first multi-mode laser 10 and the first polarization maintaining VOA 20 and transmits only a single linearly polarized wave of the first pump light output from the first multi-mode laser 10.

The second polarizer 25 is provided between the second multi-mode laser 11 and the second polarization maintaining VOA 21 and transmits only a single linearly polarized wave of the second pump light output from the second multi-mode laser 11.

An optical output of a semiconductor laser is typically a single linearly polarized wave, and the first polarization maintaining optical waveguide 14 and the second polarization maintaining optical waveguide 15 propagate light while holding the linearly polarized wave. However, since a polarization extinction ratio is limited, it is not possible to completely maintain the single polarized wave by each longitudinal mode, and slight polarization rotation may occur. Since how the optical output appears is not secured when a polarized wave other than the linearly polarized wave is input to the first polarization maintaining VOA 20 and the second polarization maintaining VOA 21, there is a likelihood that operation instability of pump light may occur.

Thus, the linearly polarized wave is secured by installing the first polarizer 24 before the first polarization maintaining VOA 20 and installing the second polarizer 25 before the second polarization maintaining VOA 21 in the third embodiment. As a result, it is possible to more stably output pump light.

### Modification Example 1 of Third Embodiment

Since a polarizer can also function as an isolator depending on its configuration, the pump light generation unit 50c may be configured to include an isolator as in the second embodiment. In a case of such a configuration, the isolator may be installed between the polarizer and the polarization maintaining VOA, for example.

### Modification Example 2 of Third Embodiment

The pump light generation unit 50c may be configured to include the first polarization maintaining optical amplifier 30 and the second polarization maintaining optical amplifier 31 instead of the first polarization maintaining VOA 20 and the second polarization maintaining VOA 21 similarly to the first embodiment.

### Modification Example Common to First to Third Embodiments

Although a case where the pump light generation unit according to each embodiment generates pump light in an optical transmission system using the Raman amplification has been described, the pump light generation unit may be used to generate pump light for a purpose other than the Raman amplification, for example, for exciting an optical fiber doped with a rare earth element.

In each embodiment, the configuration in which two multi-mode lasers that output substantially the same wavelengths are used has been described. In each embodiment, a configuration using an even number of multi-mode lasers more than two multi-mode lasers by combining, with a wavelength multiplexing coupler, outputs from two multi-mode lasers that output a wavelength of 1.45 μm and two multi-mode lasers that output a wavelength of 1.49 μm, for example.

### Fourth Embodiment

In the aforementioned first to third embodiments, how to set mutual intervals of the longitudinal modes of the first multi-mode laser 10 or the second multi-mode laser 11 arranged inside the forward pump light generation unit 300 or the backward pump light generation unit 400 illustrated in FIG. 10, that is, Δf₁₊, Δf₁₋, Δf₂₊, and Δf₂₋ is focused on. However, in a case where the band of the optical signal output from the optical transmitter 100 illustrated in FIG. 10 and the wavelength intervals in a case where the optical signal output from the optical transmitter 100 is a wavelength multiplexed signal are not discussed in the first embodiment to the third embodiment described above. Thus, the configuration of the optical amplification device in consideration of these values will be described in a fourth embodiment.

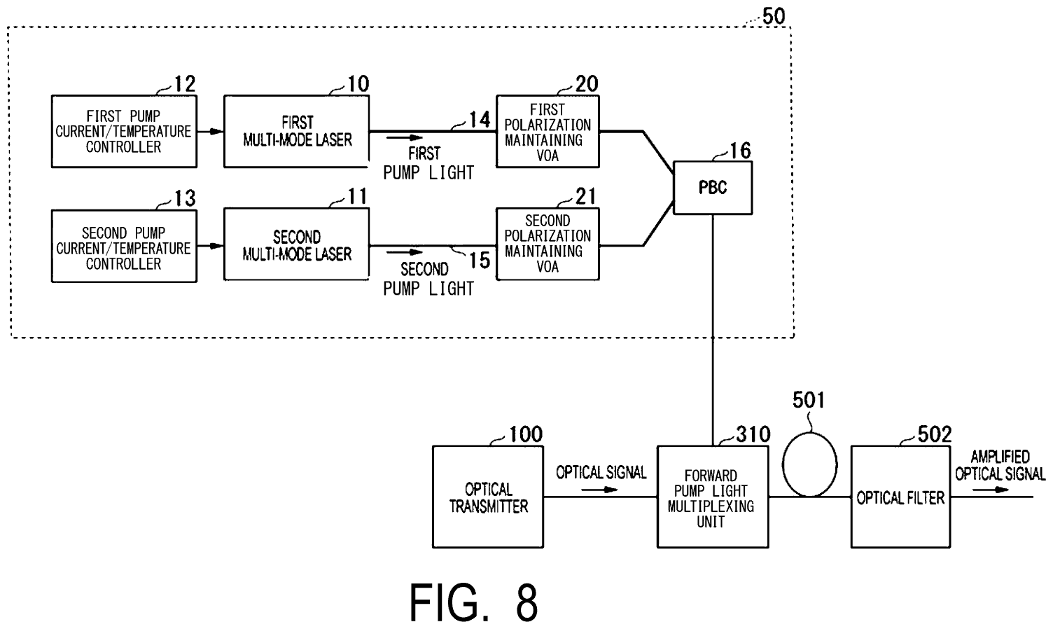

FIG. 8 is a diagram illustrating a configuration example of the optical amplification device according to the fourth embodiment. The optical amplification device includes a forward pump light generation unit 50, a forward pump light multiplexing unit 310, a gain medium 501, and an optical filter 502. An optical signal output from the optical transmitter 100 is input to the gain medium 501 via the forward pump light multiplexing unit 310. The optical signal is a digital optical signal with a baud rate of f_{b} constituted of a single carrier wavelength. The gain medium 501 may have distribution amplification using an optical transmission line as illustrated in FIG. 10 or may be an optical amplifier with a compact configuration by using an optical wavelength with a relatively short length.

An internal configuration of the forward pump light generation unit 50 is a configuration in which the first multi-mode laser 10 and the second multi-mode laser 11 are polarization-multiplexed. Although the configuration in FIG. 1 described in the first embodiment is used as the internal configuration of the forward pump light generation unit 50 in the example illustrated in FIG. 8, the present invention is not limited thereto, and the configuration in FIG. 6 described in the second embodiment may be used, for example.

Polarization-multiplexed pump light is input to the gain medium 501 via the forward pump light multiplexing unit 310. Although the optical amplification is performed only by performing forward pumping in the present embodiment, bi-directional pumping may be performed, or a configuration in which light amplification is performed only by backward pumping may be employed, by using the backward pump light multiplexing unit 410 and the backward pump light generation unit 400 as illustrated in FIG. 10. In this configuration is employed, the optical amplification device also includes the configurations of the backward pump light multiplexing unit 410, the backward pump light generation unit 400, and the like. Light amplified by the gain medium 501 is transmitted through an optical filter 502. The optical filter 502 blocks the remaining pump light. The optical filter 502 may be omitted if absorption of pump light of the gain medium 501 is high.

Here, what kinds of noise components each of the first pump light output from the first multi-mode laser 10 and the second pump light output from the second multi-mode laser 11 has before being multiplexed will be considered. As illustrated in FIG. 2, it is possible to consider that the pump light is a group of a plurality of CW light beams keeping constant frequency intervals. Here, the longitudinal mode intervals of the first multi-mode laser 10, that is, f_{1_n+1}-f_{1_n} is defined as δf₁. Similarly, the longitudinal mode intervals of the second multi-mode laser 11, that is, f_{2_n+1}-f_{2_n} is defined as δf₂. As is obvious from FIG. 2, δf₁=Δf₂₊+Δf₂₋, and δf₂=Δf₁₊+Δf₁₋ are satisfied.

It is assumed that the first multi-mode laser 10 is a mode locked laser. In the mode locked laser, a relative relationship of optical phases of each longitudinal mode is strictly controlled, and a time interval of the optical output has a pulse shape of 1/δf₁. Therefore, an output of the mode locked laser includes a very strong intensity modulation component, and the basic frequency thereof is δf₁. In a case where the Raman amplification is performed by using such pump light, intensity noise RIN that the pump light has transitions to the amplified light, and the intensity noise of the frequency δf₁ is superimposed on the amplified light. This is called RIN transfer. In order to curb the RIN transfer, the mode locked laser is typically not used for a pump light source of the Raman amplification. In this case, the relative relationship of the optical phases of each longitudinal mode becomes random, the intensity of the pump light becomes substantially constant rather than the pulse shape, and the RIN transfer of the frequency δf₁ is also curbed. However, the likelihood that the optical phases of the longitudinal modes instantaneously become the same (or become substantially the same) by chance cannot be denied even in a case where the first multi-mode laser 10 is not the mode locked laser, and it is not always possible to ignore RIN of the frequency of that the pump light has.

A case where RIN of the frequency σf₁ or δf₂ that the pump light has is high and it is not possible to ignore the RIN transfer to the amplified light will be considered. In this case, the intensity noise of the frequency δf₁ or the frequency δf₂ are superimposed on the optical signal output from the optical transmitter 100, and a noise spectrum thereof is generated at a location away from the carrier frequency of the optical signal by δf₁ or δf₂. In a case where the band of the optical signal is wider than δf₁ or δf₂, these noise components may degrade signal quality.

In order to solve this problem, it is only necessary to design the cavity lengths of the first multi-mode laser 10 and the second multi-mode laser 11 such that δf₁ and δf₂ become higher than the band of the optical signal output from the optical transmitter 100. A higher frequency than the signal band is not needed for demodulation when the optical signal is received and can be removed by a filter within a demodulator, noise components of δf₁ and δf₂ is superimposed on the signal light through the RIN transfer are thus removed, and no influences occur on the demodulation result.

Since the band of the optical signal output from the optical transmitter 100 also strongly depends on the signal format and is thus not simple, in a case where the optical signal is a digital signal, the first multi-mode laser 10 and the second multi-mode laser 11 are designed such that δf₁ and δf₂ are higher than the baud rate of the signal as one guideline.

According to the fourth embodiment configured as described above, it is possible to remove influence of noise components caused by the RIN transfer.

### Modification Example of Fourth Embodiment

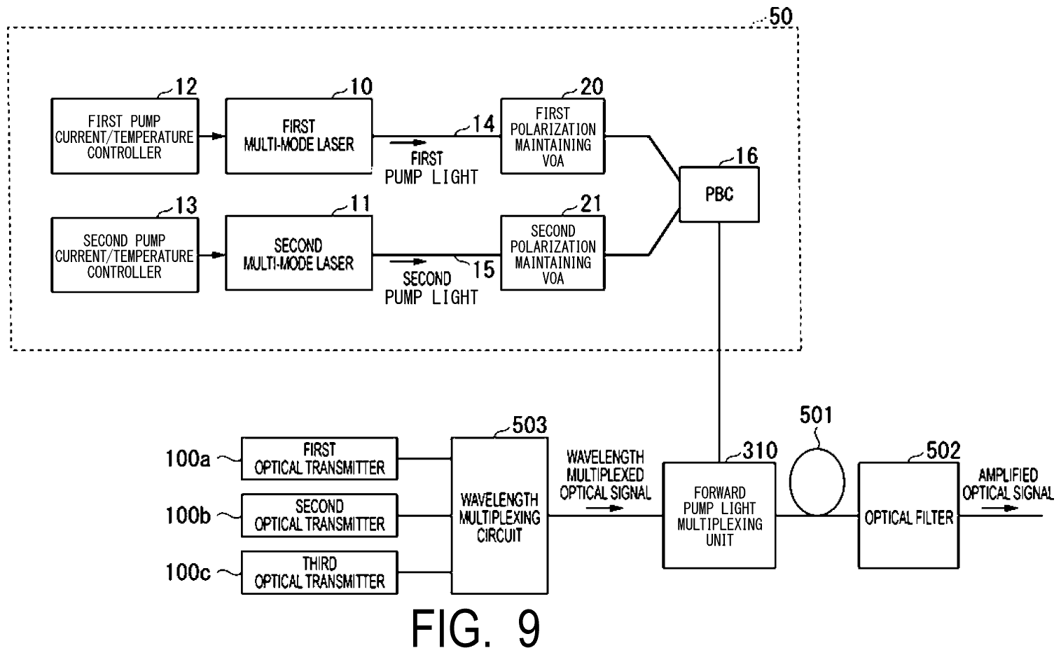

In FIG. 8, it is assumed that the optical signal output from the optical transmitter 100 is a digital optical signal with a baud rate of f_{b} constituted of a single carrier wavelength. On the other hand, it is also possible to employ a configuration in which wavelength multiplexed signals using a plurality of carrier wavelengths are collectively amplified as illustrated in FIG. 9. Optical signals having three kinds of carrier wavelengths output from the first optical transmitter 100a, a second optical transmitter 100b, and a third optical transmitter 100c are wavelength-multiplexed by the wavelength multiplexing circuit 503. Although multiple carrier frequencies are typically aligned at equal intervals on an optical spectrum in a wavelength multiplexed signal, noise components of δf₁ and δf₂ overlapping each carrier frequency overlap adjacent carrier frequencies, and this may degrade signal quality of the entire wavelength multiplexed signal, in a case where the intervals of the carrier frequencies are equal to δf₁ or δf₂. In order to avoid this problem, it is desirable to perform design such that the frequency intervals of adjacent optical channels are different from δf₁ and δf₂.

Various physical phenomena as well as the aforementioned RIN transfer may be involved in noise components generated by the Raman amplification. For example, four-wave mixing occurring in each longitudinal mode and the optical signal described in Paragraph 0018, for example, may also be noise. If four-wave mixing occurs, noise components occur in the light frequencies away from the carrier frequency of the optical signal at the center by Δf₁₊, Δf₁₋, Δf₂₊, and Δf₂₋. These noise components can also be factors of signal degradation similarly to the aforementioned noise components due to the RIN transfer. In order to avoid these influences, it is only necessary to design the first multi-mode laser 10 and the second multi-mode laser 11 such that Δf₁₊, Δf₁₋, Δf₂₊, and Δf₂₋ are greater than the baud rate of the signal similarly to the method of curbing the aforementioned noise components due to the RIN transfer. In a case where the optical signal output from the optical transmitter 100 is a wavelength multiplexed signal, it is desirable that the frequency intervals of the adjacent channels be designed to be different from Δf₁₊, Δf₁₋, Δf₂₊, and Δf₂₋.

According to the fourth embodiment configured as described above, it is possible to remove influences of the noise components occurring due to four-wave mixing.

Although the embodiments of the present invention have been described in detail with reference to the drawings, specific configurations are not limited to the embodiments and include design and the like within the scope of the present invention without departing from the gist of the present invention.

### INDUSTRIAL APPLICABILITY

The present invention can be applied to a technique of an optical amplifier using pump light.

### REFERENCE SIGNS LIST

10 First multi-mode laser
11 Second multi-mode laser
12 First pump current/temperature controller
13 Second pump current/temperature controller
14 First polarization maintaining optical waveguide
15 Second polarization maintaining optical waveguide
16 PBC
20 First polarization maintaining VOA
21 Second polarization maintaining VOA
22 First isolator
23 Second isolator
24 First polarizer
25 Second polarizer
30 First polarization maintaining optical amplifier
31 Second polarization maintaining optical amplifier
50, 50a, 50b, 50c Pump light generation unit
501 Gain medium
502 Optical filter

1. A pump light generation device comprising:
a first multi-mode laser configured to output first pump light;
a second multi-mode laser configured to output second pump light;
a first pump current/temperature controller configured to control a temperature and a pump current of the first multi-mode laser;
a second pump current/temperature controller configured to control a temperature and a pump current of the second multi-mode laser;
a first polarization maintaining variable optical attenuator configured to receive the first pump light as an input, adjusts a light intensity of the first pump light while keeping a polarization state of the first pump light in a linearly polarized wave and outputs the first pump light;
a second polarization maintaining variable optical attenuator configured to receive the second pump light as an input, adjusts a light intensity of the second pump light while keeping a polarization state of the second pump light in a linearly polarized wave, and outputs the second pump light; and
a polarization multiplexing circuit configured to polarization-multiplex and outputs the first pump light with the light intensity adjusted by the first polarization maintaining variable optical attenuator and the second pump light with the light intensity adjusted by the second polarization maintaining variable optical attenuator,
wherein the first pump current/temperature controller and the second pump current/temperature controller control at least either pump currents or temperatures of the first multi-mode laser and the second multi-mode laser such that the longitudinal modes included in the first pump light and the longitudinal modes included in the second pump light do not overlap each other, and
the first polarization maintaining variable optical attenuator and the second polarization maintaining variable optical attenuator perform control such that intensities of the first pump light and the second pump light are equal to each other.

2. The pump light generation device according to claim 1,
wherein the first pump current/temperature controller and the second pump current/temperature controller control at least either the pump currents or the temperatures of the first multi-mode laser and the second multi-mode laser such that the longitudinal modes included in the first pump light and the longitudinal modes included in the second pump light do not overlap each other and the first pump light has higher power than the second pump light.

3. A pump light generation device comprising:
a first multi-mode laser configured to output first pump light;
a second multi-mode laser configured to output second pump light;
a first pump current/temperature controller configured to control a temperature and a pump current of the first multi-mode laser;
a second pump current/temperature controller configured to control a temperature and a pump current of the second multi-mode laser;
a first polarization maintaining optical amplifier configured to receive the first pump light as an input, amplifies a light intensity of the first pump light while keeping a polarization state of the first pump light in a linearly polarized wave, and outputs the first pump light;
a second polarization maintaining optical amplifier configured to receive the second pump light as an input, amplifies a light intensity of the second pump light while keeping a polarization state of the second pump light in a linearly polarized wave, and outputs the second pump light; and
a polarization multiplexing circuit configured to polarization-multiplex and outputs the first pump light with the light intensity amplified by the first polarization maintaining optical amplifier and the second pump light with the light intensity amplified by the second polarization maintaining optical amplifier,
wherein the first pump current/temperature controller and the second pump current/temperature controller control at least either pump currents or temperatures of the first multi-mode laser and the second multi-mode laser such that longitudinal modes included in the first pump light and longitudinal modes included in the second pump light do not overlap each other, and
the first polarization maintaining optical amplifier and the second polarization maintaining optical amplifier perform control such that the intensities of the first pump light and the second pump light are equal to each other.

4. The pump light generation device according to claim 1,
wherein a first isolator configured to block an input of reflected light is arranged at an output of the first multi-mode laser, and
a second isolator configured to block an input of reflected light is arranged at an output of the second multi-mode laser.

5. The pump light generation device according to claim 1,
wherein a first polarizer configured to transmit a single linearly polarized wave is arranged at an output of the first multi-mode laser, and
a second polarizer configured to transmit a single linearly polarized wave is arranged at an output of the second multi-mode laser.

6. The pump light generation device according to claim 1,
wherein, in a case where one arbitrary light frequency of longitudinal modes included in the first pump light is defined as f_{1_n}, a difference in light frequencies from a longitudinal mode that is smaller than fin and is the closest to fin from among the longitudinal modes included in the second pump light is defined as Δf₁₋, and a difference in light frequencies from a longitudinal mode that is greater than f_{1_n} and is the closest to f_{1_n} from among the longitudinal modes included in the second pump light is defined as Δf₁₊,
the first pump current/temperature controller
sets at least either the pump current or the temperature of the first multi-mode laser to minimize the number of combinations that satisfy |Δf₁₊|=|Δf₁₋|, and
in a case where one arbitrary light frequency of the longitudinal modes included in the second pump light is defined as f_{2_n}, a difference in light frequencies from a longitudinal mode that is smaller than f_{2_n} and is the closest to f_{2_n} from among the longitudinal modes included in the first pump light is defined as Δf₂₋, and a difference in light frequencies from a longitudinal mode that is greater than f_{2_n} and is the closest to f_{2_n} from among the longitudinal modes included in the second pump light is defined as Δf₂₊,
the second pump current/temperature controller
sets at least either the pump current or the temperature of the second multi-mode laser to minimize the number of combinations that satisfy |Δf₂₊|=|Δf₂₋|.

7. The pump light generation device according to claim 6,
wherein a constant that is defined in advance to be greater than 0 and smaller than 1 is defined as R, |Δf₁₊|=|Δf₁₋| is allowed in relation to the longitudinal modes having intensities of equal to or less than P_{1_max}×R when a longitudinal mode with the maximum optical power in the first pump light is defined as P_{1_max}, and |Δf₂₊|=|Δf₂₋| is allowed in relation to the longitudinal modes having intensities of equal to or less than P_{2_max}×R when the longitudinal mode having the maximum optical power in the second pump light is defined as P_{2_max}.

8. An optical amplification device comprising:
a first multi-mode laser configured to output first pump light with longitudinal mode frequency intervals of δf₁;
a second multi-mode laser configured to output second pump light with longitudinal mode frequency intervals of δf₂;
a first pump current/temperature controller configured to control a temperature and a pump current of the first multi-mode laser;
a second pump current/temperature controller configured to control a temperature and a pump current of the second multi-mode laser;
a polarization multiplexing circuit configured to polarization-multiplex and outputs the first pump light and the second pump light; and
a gain medium, to which all of an optical signal and the first pump light and the second pump light output from the polarization multiplexing circuit are input, the gain medium amplifying and then outputting the optical signal,
wherein the first pump current/temperature controller and the second pump current/temperature controller control at least either pump currents or temperatures of the first multi-mode laser and the second multi-mode laser such that longitudinal modes included in the first pump light and longitudinal modes included in the second pump light do not overlap each other, and
in a case where the optical signal amplified by the first pump light and the second pump light is a digital signal of a baud rate f_{B}, the frequency intervals δf₁ and δf₂ of the longitudinal modes are greater than the baud rate f_{B}.

9. The optical amplification device according to claim 8, wherein the optical signal is a wavelength multiplexed signal with adjacent wavelength channel light frequency intervals of f_{WDM}, and the longitudinal mode frequency intervals δf₁ and δf₂ are values that are different from the adjacent wavelength channel light frequency intervals f_{WDM}.

10. The optical amplification device according to claim 8,
wherein, in a case where one arbitrary light frequency of longitudinal modes included in the first pump light is defined as f_{1_n}, a difference in light frequencies from a longitudinal mode that is smaller than the light frequency f_{1_n} and is the closest to the light frequency f_{1_n} from among the longitudinal modes included in the second pump light is defined as Δf₁₋, and a difference in light frequencies from a longitudinal mode that is greater than the light frequency f_{1_n} and is the closest to the light frequency f_{1_n} from among the longitudinal modes included in the second pump light is defined as Δf₁₊, the first pump current/temperature controller sets at least either the pump current or the temperature of the first multi-mode laser to minimize the number of combinations that satisfy |Δf₁₊|=|Δf₁₋|, and
in a case where one arbitrary light frequency of the longitudinal modes included in the second pump light is defined as f_{2_n}, a difference in light frequencies from a longitudinal mode that is smaller than the light frequency f_{2_n} and is the closest to the light frequency f_{2_n} from among the longitudinal modes included in the first pump light is defined as Δf₂₋, and a difference in light frequencies from a longitudinal mode that is greater than the light frequency f_{2_n} and is the closest to the light frequency f_{2_n} from among the longitudinal modes included in the second pump light is defined as Δf₂₊, the second pump current/temperature controller sets at least either the pump current or the temperature of the second multi-mode laser to minimize the number of combinations that satisfy |Δf₂₊|=|Δf₂₋|.

11. The optical amplification device according to claim 10, wherein, in a case where the optical signal is a digital signal with a baud rate f_{B}, the differences Δf₁₊, Δf₁₋, Δf₂₊, and Δf₂₋ of the light frequencies are greater than the baud rate f_{B}.

12. The optical amplification device according to claim 10, wherein all the differences Δf₁₊, Δf₁₋, Δf₂₊, and Δf₂₋ of the light frequencies are values that are different from the adjacent wavelength channel light frequency intervals f_{WDM}.

13. (canceled)
